(19) United States
(12) Patent Application Publication
(10) Pub. No.: US 2005/0260378 A1
(43) Pub. Date: Nov. 24, 2005

(54) Procedure to obtain flocked surfaces with white and coloured flocking during the carrying out of the process, with one, two or more colours in the hair/flocking material, and the final product

(76) Inventor: Rafael Pascual Bernabeu, Muro de Alcoy (ES)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 11/132,848

(22) Filed: May 19, 2005

(30) Foreign Application Priority Data
May 21, 2004 (ES) 200401224

(51) Int. Cl. B32B 33/00; B05D 1/14; B05D 1/16

(52) U.S. Cl. 428/90; 427/463; 427/464; 427/462

(57) ABSTRACT

A procedure is described to obtain flocked surfaces starting out from white flocking, which at the end of the process will be coloured to the tone or tones required, with one, two or more colours whose surfaces include a layer of an adhesive material and the flocking material, the process comprising of different stages for the applying of a layer of adhesive with incorporated sublimable colourings, onto the surface of the fabric or base to be flocked; the flocking of said surface with white flocking material by means of electrostatic-mechanical means of distribution; the drying and thermo-fixing of the flocked surface onto the adhesive material layer; and the sublimation of the flocked surface by means of the application of heat, in such a way that the sublimable product in the flocking colours in an ascending direction, from the base of the surface up to upper part of the flocking.

### OBJECT OF THE INVENTION

The present invention refers to a procedure to obtain flocked surfaces with white and coloured flocking during the carrying out of the process, with one, two or more colours in the hair/flocking material, and the final product, which contributes several advantages and novelty characteristics in comparison to the methods currently known and used for the same purposes in the present state of the art.

More specifically, the invention proposes the development of a procedure for the obtaining of flocked surfaces with one, two or more colours in the hair/flocking material, likewise the obtaining of a flocked surface over the entirety with white or pale coloured flocking which at the end of the process has coloured flocking without having to resort to prior dyeing using the conventional processes with the use of water, and in which the product obtained includes significant innovations and advantages over similar products obtained using the conventional processes by means of which it is not possible to apply white flocking and obtain the colouring of same in the flocking process.

The invention refers to procedure to obtain flocked surfaces with white and coloured flocking, previously cut, made from nylon or polyester, which already has the coloured flocking, in the colour or colours required, once the process that is going to be described has been finished.

The field of application of the invention is to be found, obviously, amongst the industrial sector that is involved in the manufacture of fabrics for the upholstering of furniture, the insides of cars, carpets, footwear, rugs and surface coverings, and other applications.

### BACKGROUND AND SUMMARY OF THE INVENTION

At the present time a multitude of flocked fabrics are known which have a dyed flocked surface, and whose dyed surface has normally been obtained, either by dyeing the flocking material prior to be flocked, or equally by the dyeing of the piece of fabric after being flocked.

Likewise, there are flocked fabrics that have their entire surface flocked with white flocking, said surface being subsequently decorated with designs that have different shapes and colour tones, obtained by the printing of same using the different known printing techniques, after being flocked.

There are also fabrics known that have their surfaces partially flocked, with the flocking having being previously dyed, onto a base fabric that has been previously dyed or even that is not dyed.

Also, and as an alternative to the above, there are partially flocked fabrics, with white or coloured flocking, this also having been obtained by prior dyeing, onto the fabric that has been previously been printed in different shapes and colours, with the disadvantage that, normally, the shapes printed onto the fabric do not exactly correspond to the partial flocked shapes made onto same.

On the other hand, by means of the Spanish patent number P-200102663, the owner of which is the same as the presenter of this present invention, the existence of a machine is known by which it is possible to carry out the calendering, printing, flocking, engraving, drying, thermo-fixing and combing operations in one single processing operation, for the production of printed and flocked fabrics, in the description of which mention is already made of the possibility of obtaining surfaces that are partially printed in several colours and partially flocked, in coloured flocking, this being obtained by the prior dyeing of same, to surfaces on non-printed surface sections, in addition allowing the partially flocked surface sections to be accompanied, surrounded or completed by sections of printed fabric, in such a way that the design or drawing required by the manufacturer is achieved. This allows a final decoration of the fabric to be achieved that is made up of a single colour of flocking material in the flocked sections, and a variety of colours to be obtained by the printing of the fabric onto the non-flocked surface sections.

Thus, the procedures currently existing only allow the obtaining of a flocked surface with single colour flocking.

This present invention has been proposed with the basic object of providing a procedure by which it is possible to carry out flocking with white flocking material, and in which in the final process the flocking has been coloured in one or more different colours in specific areas of the flocking. This object has been fully achieved by means of the procedure that is going to be the object of the description which follows, and whose main characteristics are included in the part which is characterised in claim number 1.

In essence the procedure put forward by the invention and which is going to be the object of the description which follows, allows the historical impossibility to be solved of obtaining surfaces flocked with white flocking, and at the end of the flocking process for the white flocking to be coloured to the colour or colours previously specified in accordance with the requirements of the user, this meaning, that in specific areas of the flocking there is one, two or more colours, in addition including other additional advantages that will be clear from the description that is given below.

For this purpose, the procedure proposed by the invention includes a succession of treatment stages to which the fabric is subjected, and amongst which the application of adhesives with one or more sublimable colours must be highlighted, to the portions of the base that it is required to flock, the flocking operation with white flocking material onto the surface, the drying and thermo-fixing stage of the surface to be flocked on the adhesive layer, and the sublimation stage to colour the flocking in an ascending manner from the adhesive layer. In this way, depending on the sublimable colourings that are used and the zones onto which they are applied, the desired designs can be achieved, in the previously determined colour tones.

In another method of the preferred embodiment, in which the flocking on all of the surface is attempted, the fabric or base is impregnated with adhesive over the entire surface, with which, the adhesive formulated with sublimation colours will be subjected to the following operations up to the final sublimation phase, obtaining a surface that is completely flocked and coloured in one, two or more colours on the flocking as a result, without the need for any prior or subsequent dyeing process to the flocking.

### DESCRIPTION OF A PREFERRED EMBODIMENT

As and how stated above, the detailed description of the preferred embodiment of the process proposed by the invention is going to be carried out below by means of a more exhaustive description of the different stages or phases envisaged by the procedure. For this purpose, in accordance with the invention, the obtaining of flocked surfaces with white flocking, and the colouring of this with one, two or more colours at the end of the process of this present invention is made up of the following stages:
a) The applying of adhesive to the base to be flocked, in the case of partial flocking of the surface by means of perforated mesh cylinders onto which the design has been defined, or by means of a gauged doctor blade system for the case of the complete flocking of the surface, whose adhesive has had colourings added in its formulation with the power of sublimation to the flocking material, and in the case in which there are several, each one of them with a different colour tone, using as many adhesive feed cylinders as there are final colours in the flocking that is required;
b) The carrying out of a flocking phase onto the surface as stated in the previous stage, with the use of white flocking, carrying out the distribution by means of the use of some technique that uses electrostatic or mechanical means;
c) Next a drying and thermo-fixing stage is carried out of the flocked surface onto the adhesive material layer; and
d) Finally, the sublimation phase of the flocked surface is carried out by means of the application of heat in a controlled manner in so far as temperature and application time, in such a way that the coloration of the flocking is produced in an ascending direction, from the adhesive layer up to the upper part of the flocking, thus obtaining with it a surface of fabric, paper or other suitable material which has its surfaces covered with flocking in one, two or more colours by virtue of the heat sublimable nature of the colourings used.

As an additional characteristic, the invention has provisioned that the adhesive for application can include accelerant components in such a way that the velocity of the sublimation phase can be accelerated.

In one form of optimal embodiment, the different stages of the procedure that has just been described can be carried out in a continuous process, without interruption, when the surface to be flocked is in a partial manner, in which case the use of a single machine of the type described in the Spanish patent number P-200102663, held by the same owner, would be especially suitable, with which, as has been stated, it is possible to carry out all of the operations necessary for the formulation of the flocked surfaces, in addition to reducing the overall process time.

In accordance with the above description, it will be understood that the most efficient embodiment of the procedure, is that which where stage d) of sublimation is carried out in the same process and pass of the other stages, but at the end of the latter; however, in a less efficient manner, the invention has also provisioned that the sublimation stage can be carried out in a separate process.

On the other hand, it is also easily understood that the execution of the procedure proposed by the invention allows the obtaining, as the final product, of a flocked fabric with some advantageous characteristics in comparison to that which is presently known, given that the surface flocked with flocking can be coloured with a single colour, or equally it can include two or more colours at the end of the described process, thanks to the incorporation of the sublimable colouring or colourings together with the adhesive in stage a) of the process described above, and especially with a perfect outlining of each one of the coloured areas.

In addition, in contrast to other processes of the prior state of the art, the procedure of the invention also has the advantage that the colouring the flocking material is carried out dry, without the use of water, which represents significant financial savings in process times, savings by not using water, likewise energy savings that are required for the dyeing by means of aqueous baths, which always have to be carried out at minimum boiling temperatures, at the same time avoiding the generation of heat for the heating of same, and the additional saving in not having to dispose of waste, the treatment of which is usually costly as they have to be filtered in accordance with the legislation, thus achieving an overall more ecological process.

It is not considered to be necessary to make the content of this description more lengthy in order for an expert in the subject to be able to understand its scope and the advantages to be derived from the invention, likewise to develop and carry the object of same into practice.

However, it must be understood that the invention has been described in accordance with a preferred embodiment of same, by which modifications are likely to be made but without meaning any alteration of the bases of the said invention, such modifications being able to affect the form, size and/or manufacturing materials.

1. A method for obtaining flocked surfaces with white and coloured flocking during the carrying out of the process, with one, two or more colours in the hair/flocking material, aimed especially to provide the flocking material with a colouring in one or more colours in specific areas of the flocking material that have been previously chosen, said surfaces having a layer of adhesive material and material for flocking and by means of the use of one or several applications of an adhesive that includes previously chosen colourings, having heat sublimable nature, the method comprising the following steps:
a) The applying of adhesive which is formulated with sublimable colourings in order to obtain a final single colour, or equally by applying several adhesives, each formulated with different tones of sublimable colourings, each one spread to a part of the fabric to achieve an equivalent number of colours;
b) The carrying out of a white flocking phase on the surface chosen, by means of electrostatic or mechanical distribution;
c) The carrying out of a drying and thermo-fixing stage of the flocked surface onto the adhesive material layer; and
d) The applying of heat to the flocked layer for the purpose of bringing about the sublimation of the colourings included in the adhesive for the purpose of achieving the colouring of the flocked surface, in an ascending direction from the adhesive layer to the upper part of the flocking.

2. The method in accordance with claim 1 wherein the adhesive applied includes accelerant components to increase the speed of the sublimation stage.

3. The method in accordance with claim 2 further comprised of the step of colouring of the flocking material by means of a dry process.

4. A flocked fabric obtained from the procedure of claim 3 having a flocked surface that has one, two or more colours in the flocking material, which was white at the point of being flocked.
